(19) United States
(12) Patent Application Publication
(10) Pub. No.: US 2008/0027781 A1
(43) Pub. Date: Jan. 31, 2008

(54) Method for monitoring and controlling workflow of a project, applications program and computer product embodying same and related computer systems

(76) Inventors: Gregor Alexander vom Scheidt, Munich (DE); Martin Loeseke, Munich (DE); Achim Pfefferle, Germering (DE); Jens Riemschneider, Munich (DE); Jochen Pielage, Munich (DE); Merten Stroetzel, Pacific Palisades, CA (US)

Correspondence Address: PETER J. GORDON, PATENT COUNSEL, AVID TECHNOLOGY, INC., ONE PARK WEST, TEWKSBURY, MA, 01876, US

(21) Appl. No.: 11/881,576

(22) Filed: Jul. 27, 2007

Related U.S. Application Data
(63) Continuation of application No. 10/300,674, filed on Nov. 20, 2002, now abandoned.

(51) Int. Cl. G06F 9/46

(52) U.S. Cl. 705/8

(57) ABSTRACT

Featured is a method for controlling work of a project, that is particularly suited for controlling development of files of a software project. Such a method broadly includes defining S status levels (S≧2), where the number and definition of each status level relates to at least certain of the workflow paths of the project workflow and defining U user statusing rights sets (U≧2), one user rights set for each type of user. The method also includes classifying each work item as one of being within or being without the workflow and using the S status levels to define a work status for each work item classified as being within the workflow. The method also includes assigning the work item and a work status change control process whereby changes in work status are permitted based on the user statusing rights. Also featured is a computer program, program code for execution on a microprocessor and a computer system embodying such program code.

### CROSS REFERENCE TO RELATED APPLICATIONS

This application claims right of priority to and the benefit, under 35 USC §119(e), of prior filed provisional application Ser. No. 60/331,912, filed on Nov. 20, 2001, and U.S. patent application Ser. No. 10/300,674 filed on Nov. 20, 2002, pending, both of which are incorporated herein by reference.

### FIELD OF INVENTION

The present invention related to methods, applications programs and products for execution on a processor for monitoring and controlling workflow of a project and more particularly to methods, applications programs and products for execution on a processor for monitoring and controlling workflow of a software based project as well as related computer systems, more specifically, to methods, applications programs and products for execution on a processor for monitoring and controlling workflow of a software based project in the area of interactive entertainment such as computer games.

### BACKGROUND OF THE INVENTION

In the software industry, particularly that involving content development for interactive entertainment such as computer games and the like, the software product typically includes digital files, image files, audio files and programs files that number in the thousands, typically about 10,000 or more of such computer files. Although there is a very large number of files comprising such a project typically the number of files that are considered particularly important or key to the project and thus for work monitoring number about 100-500 or so. In addition to the large number of files, the project team for developing the computer files can typically number 30 or more as well as the project being for a duration of about 2 years or more.

In addition to the large number of files and users and long project durations, the software development process is not static. For example, the number of files comprising the project and those files that are considered particularly important or key typically fluctuate throughout most of the life of the project. In addition, the files to be developed typically are not all assigned to a member of the project team at the beginning of the project. Further, the project team typically changes over time with additions and deletions requiring re-assignment of the work assignments.

Present project management practices for the development of interactive entertainment products include conducting periodic meetings and sending memorandum and the like to determine the status of elements of the project as well as the status of individual files. Such practices are cumbersome, time consuming and the information is only as good as of the date it is provided. Because the different people responding to the inquiry potentially could provide the replies at different times, the information being provided also could be inconsistent. Such practices basically try to provide a snapshot of project status as of a given moment of time, but are not always successful. As indicated above, the development process is dynamic, so it also is possible that file additions and deletions could cause changes in project completion status, thus making the identification of other development problems more difficult.

There also are a number of commercially available project management software applications programs. Such programs, however, embody a task orientated project management technique, where the project is broken down into tasks and each of these tasks is further defined by a specified time period to perform the task. In this technique the time to complete or perform a task is continually adjusted based on changing conditions or a task is added when additional work is required. A critical path analysis also is typically performed in this technique to identify the critical time path to the completion of the project.

The traditional task based management technique and the software embodying such a technique, however, has not proven to be easily adaptable or useable in an industry such as the interactive entertainment industry. The task based management technique while providing a general overall view of project status is unable to status project activities on a basis that allows statusing for all of the different possible workflow paths. Also, this technique usually does not lend itself to monitoring work of an individual, unless a single individual is performing a given task. In addition, such task based management techniques is usually undertaken in a fashion whereby the people performing the work are not inputting or updating the database. Thus, another layer or system is put in place when using task based management technique/software.

Also the task based management technique is not easily useable with workflows that are dynamic. For example, task work additions and deletions could cause changes in status for a given task, thus making the identification of other task level problems more difficult to detect and remedy. In addition, it is not an uncommon to see task additions (e.g., re-work/modification) to be treated as a new task for tracking and workflow management purposes.

It thus would be desirable to provide methods for monitoring and controlling performance and workflow particularly for that involving the creation and development of computer files. It would be particularly desirable to provide such methods that would provide a mechanism to status file development/creation autonomously in comparison to prior art methods. It also would be desirable to provide such methods that allow statusing of all possible workflow paths. Further, it would be desirable to provide such methods where those doing file development/creation input status updates. It also would be desirable to provide software, computer program products, and computer system that embody and/or implement such methodologies. Moreover, it would be desirable that such methods would not, comparatively speaking, require highly skilled users to utilize the methodology or the software, computer program products, and computer system that embody and/or implement such methodologies.

### SUMMARY OF THE INVENTION

The present invention features a method for controlling work of a project. The method is particularly suited for controlling the development of files of a software project, more specifically the development of files for an interactive entertainment project. In its broadest aspects such a method includes defining S status levels (S≧2), where the number and definition of each status level relates to at least certain of various workflow paths of a workflow for the project and defining U user statusing rights sets (U≧2), one user rights set for each type of user assigned to the project. The method also includes classifying each of the work items of the project as one of being within the workflow or being without the workflow, where there is at least one work item classified as being within the workflow and using the defined S status levels to define a work status for each work item that is classified as being within the workflow. As to such classifying and using, the method also includes classifying each work item being added to the project or re-classifying one or more work items of the project as one of being within the workflow or being without the workflow; and using the defined S status levels to define a work status for each added or re-classified work item that is classified as being within the workflow.

In further embodiments, the method includes assigning each work item that is classified as being within the workflow to one of the users assigned to the project. Also included is providing an informational database including identifiable entries for each of the work items of the project. One of the identifiable entries is one of the defined S status levels and another of the identifiable entries is representative of the one of the users assigned to the work item corresponding to identifiable entries.

The method further includes the capability of changing the work status for any of the work items classified as being in the workflow. This change process includes requesting a change in the work status for one of the work items from one of the defined S status levels to another of the defined S status levels and evaluating the user rights set of the one user requesting the change in the work status. In the case where the user rights set allows the change, the work status is changed and in the case the user rights set does not allow the change, there is no change made to the work status. In specific embodiments, a work function relating to the said one of the defined S status levels is performed before said requesting a change in the work status and a work function relating to the said another of the defined S status levels is performed after the work status change is made.

Also featured is a computer program, an applications program for execution on a computer microprocessor embodying the methodology of the present invention and a computer system embodying such an applications program/program code.

Other aspects and embodiments of the invention are discussed below.

### DEFINITIONS

The instant invention is most clearly understood with reference to the following definitions:

A computer readable medium-shall be understood to mean any article of manufacture that contains data that can be read by a computer or a carrier wave signal carrying data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIGS. 1A, B are flow diagram of a method according to the present invention illustrating functionalities at the administrative level;

FIG. 2 is a more detailed flow diagram of a portion of the method illustrated in FIG. 1A;

FIG. 3 is a flow diagram of the method according to the present invention illustrating functionalities at the work level;

FIG. 4 is an exemplary workflow status chart illustrating diagrammatically the process of defining status levels for a given exemplary project;

FIG. 5 is a view of an exemplary dialog box illustrating one software technique for changing sign-off status;

FIG. 6A, B are views of exemplary dialog boxes illustrating one software technique for administrating management of workflow files and workflow;

FIG. 7 is an exemplary bar chart style of status report illustrating one technique to status and monitor the files designated as being workflow files; and

FIG. 8 is a schematic view of a computer system including an applications program embodying the methodology of the present invention.

### DESCRIPTION OF THE PREFERRED EMBODIMENT

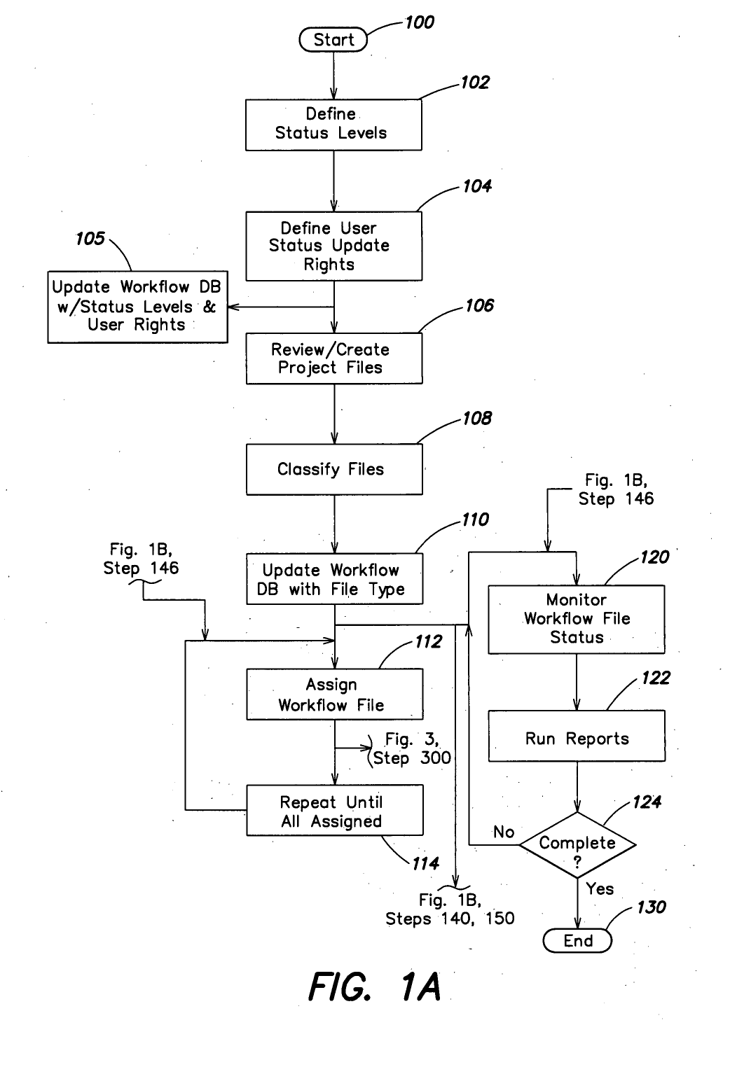

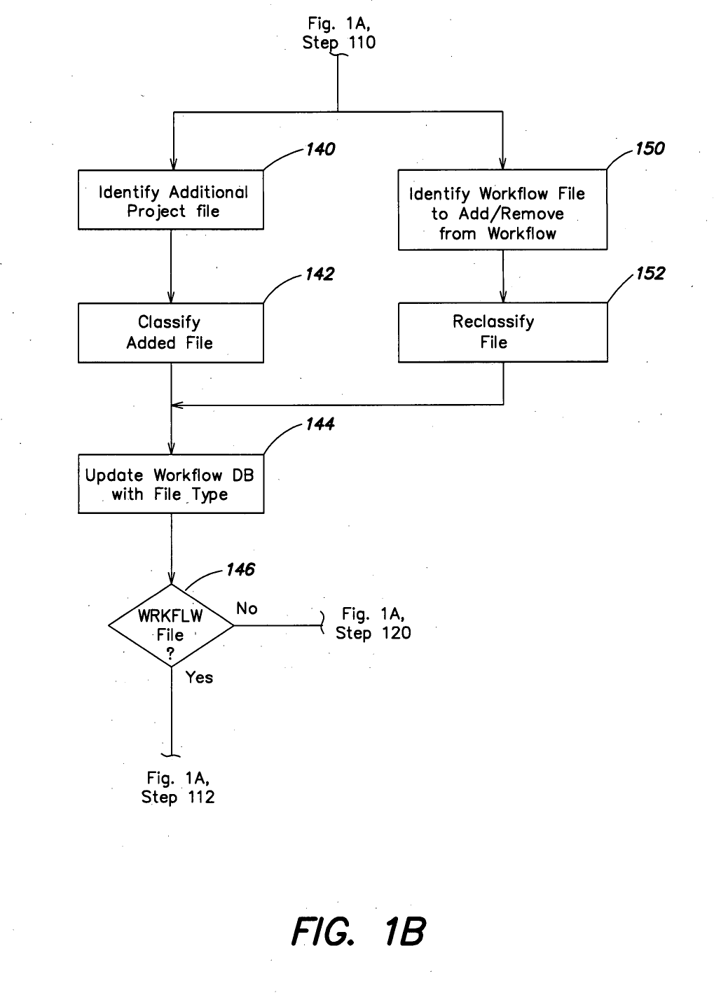

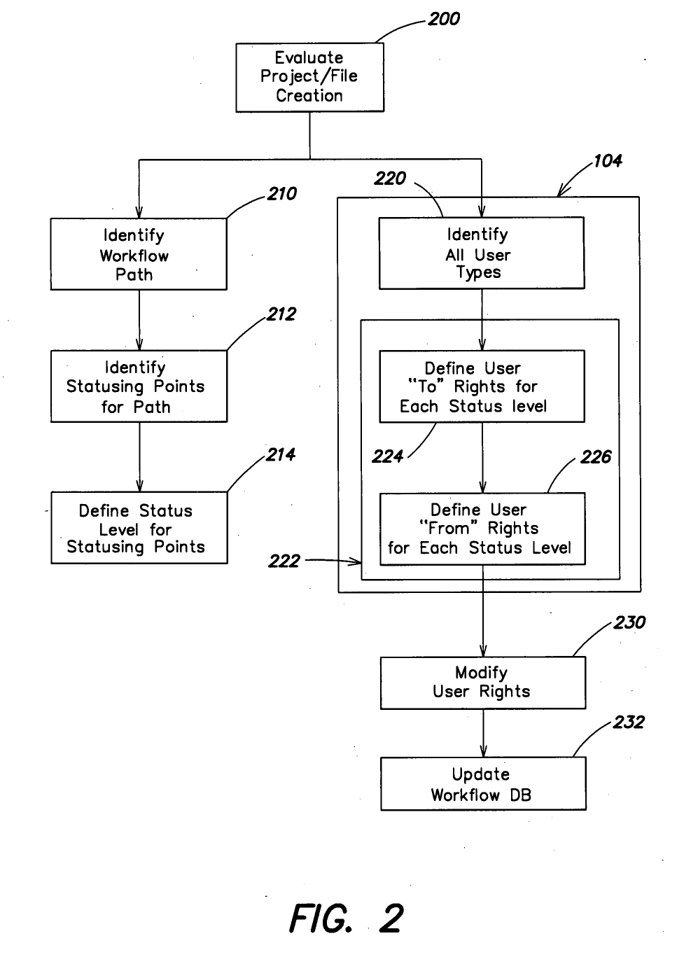

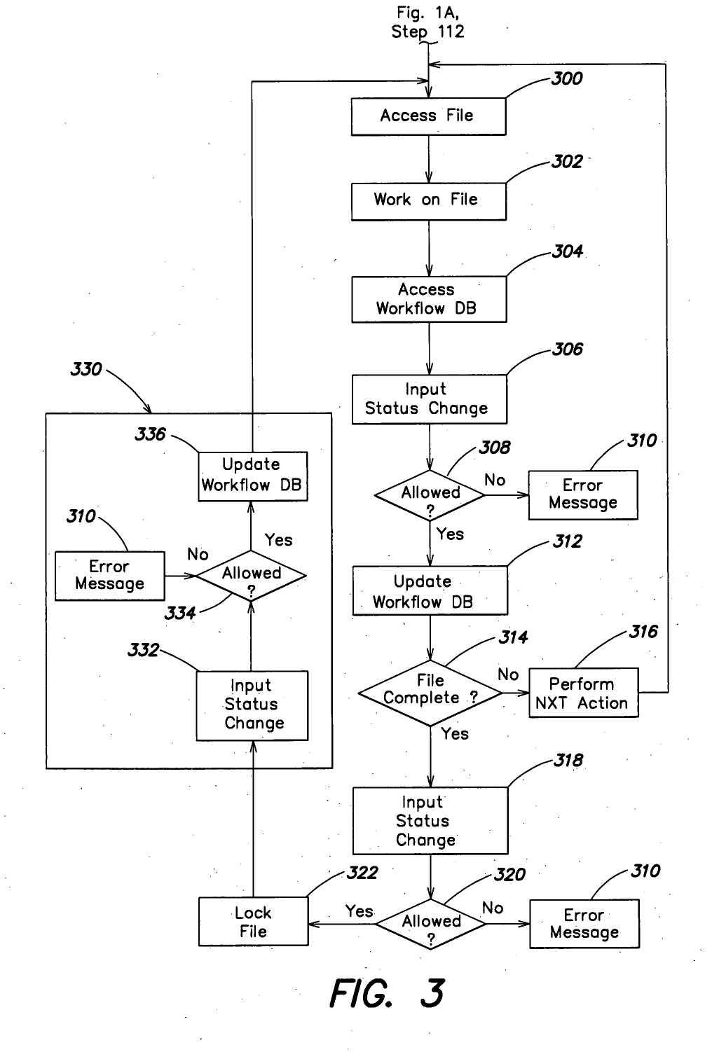

Referring now to the various figures of the drawing wherein like reference characters refer to like parts, there is shown in FIGS. 1-3 various flow diagrams that illustrate various features and/or embodiments of the methodology of the present invention for monitoring and controlling workflow of a project such as a software content development project in the interactive entertainment area including computer games and the like. More particularly, there is shown in FIG. 1A,B a flow diagram of a method according to the present invention illustrating functionalities at the administrative level and a more detailed flow diagram of a portion of the method of the present invention, specifically that involving the defining of status levels and user statusing rights of FIG. 1A is shown in FIG. 2. A flow diagram of another portion of the methodology of the present invention that illustrates the functionalities and process at the work level is shown in FIG. 3.

As explained in more detail hereinafter, according to the method of the present invention there is established a hierarchy of user accessing rights that control and limit the ability of certain groups or types of users to update workflow status. Thus for simplification of presentation, the methodology of the present invention implemented at an administrative or project management level is illustrated separate from the methodology implemented at the day-to day work level by any user. This illustration of the methodology of the present invention, however, shall not be interpreted or construed as being a limitation on the scope or functionality of such a method or embodiments thereof.

Now referring to FIG. 1A there is shown a flow diagram of the method and/or functionalities at the administrative level of that portion of the process concerning the management of workflow such as defining status levels and user status updating rights, identifying files belonging to the workflow monitoring/statusing process, and assigning files belonging to the workflow monitoring process. After the project starts, STEP 100, the various status levels of that project are defined, STEP 102, and the user status updating rights for that project also are defined, STEP 104.

Now referring also to FIG. 2, which illustrates that portion of the method of the present invention involving the defining of status levels and user statusing rights, at the beginning or shortly after the project starts, a person or group of persons evaluate the project, the various elements required to yield the product of the project, the structural elements of the project and manpower usage of the project, STEP 200. Such an evaluation also may further consider or narrow the scope of the analysis so as to focus on only those aspects of the project (e.g., computer files) that are considered important or key to the project and thus to be monitored.

Based on this evaluation, the person or persons identify a workflow that includes all possible workflow paths for the project or the items of the project to be monitored, STEP 210. It should be recognized that such a definition or identification of a workflow and the paths thereof is dependent upon the industry and the particulars of the project. In other words the protocols involved in the development of a software product consisting of a number of files in one industrial area can be different from the protocols for developing a software product in another industrial area because there are different types of files and rules governing the development of these different types of software products.

After identifying the workflow and the various paths making up the workflow, the person or persons define status points that correspond to workflow activities and/or natural transition points in the workflow paths, STEP 212. After identifying these status points, each of the identified status points is defined by a status level, STEP 214. Stated another way, a unique flag or other identifier is provided to uniquely define each of the possible status levels of the workflow. It should be recognized that the various paths that are identified and the different status levels being defined are those that cover the possible workflow paths. Thus, the actual performance of the work need not follow through each workflow path or be defined by every status level. For purposes of the present invention, there can be “WP” workflow paths and “SL” status levels, where WP is greater than or equal to two (2) and SL is greater than or equal to two (2).

After defining the various status levels of that project, STEP 102, the user status updating rights for that project are defined, STEP 104. As described in more detail hereinafter and as indicated above, there is established a hierarchy of user accessing rights that control and limit the ability of certain groups or types of users to broadly update workflow status. In addition, there also is established a hierarchy of user rights that control and limit the ability of certain groups or types of users to perform certain database modification actions and/or re-statusing of workflow status.

Initially the person or persons referred to above, identify the various users that can make up the project and categorize the users into natural groupings dependent upon the process and functions the various groupings perform, STEP 220. For example, in the simplest form of categorization the users can be categorized into an administrative or project management grouping and into simple users for another grouping.

After identifying these users types, the rights for a given user type to change a status level are defined, STEP 222. In other words, limits and bounds are established for each user types as to define the limits on that user type's ability to change a previously set status or status flag. Thus, certain types of users will be given broad authority to change status whereas others may be given limited authority. In the case of the simplest form of categorization, users categorized into an administrative or project management grouping would be give broad authority and simple users would be given limited authority.

In a more a particular embodiment, defining the rights for a given user type to change a status level includes defining the rights of particular user/user grouping to change the status “to” a given status level, STEP 224 and defining the rights of particular user/user grouping to change the status “from” a given status level, STEP 226. In this way, user rights are further defined so to permit a user/user grouping to change the status between two different status levels when moving in one direction but not allow that user/user grouping to change the status between the same two different status levels if moving in the opposite direction (see also the discussion below regarding FIG. 3, STEPS 332-336). This is typically done so that one type of user can move an item into a status category corresponding to an activity being performed by another user having greater user rights.

It should be recognized that the foregoing is not limiting as to the number of users, user types or user groupings that can be defined for a given project. It is within the scope of the present invention for the number of users “NU” to be any number greater than or equal to two (2). The actual number of users is dependent upon a number of factors including; the project type, and the work and review cycles making up the workflow. The number of user types also is typically established so as to keep usability high and the updating process simple.

As also shown in FIG. 2, following the initial defining of user rights those having administrative user rights can re-review the user status rights for a given user type and modify those user rights, STEP 230 and update the workflow database accordingly, STEP 232. Such a modification also may involve a redefining of the user types to include more or less users types. This allows the process or methodology to be adjusted dynamically during use to accommodate for changes in conditions that warrant such a modification in user rights. For example, the initial definition of user types may have been found to be in too fine a detail and thus a lesser number of user types may be defined which should be better for productivity. It also may be desirous to change the “to”/“from” user right set of a given user(s) so that the given user can perform a task that is presently assigned to those with an administrative user right set without having to give that user(s) the administrative right set.

Now referring back to only FIG. 1A, after defining the status level and user rights, STEPS 102, 104, the workflow database is updated so to include these defined status levels and user rights, STEP 105. In other words, a list of all of the possible status flags attached to the project by default and thus inheritable by any of the item (e.g., files) making up the project as well as the statusing rights of each user or user type is maintained in an informational database. The database that includes this information is used at various times during the process as hereinafter described.

The person or persons referred to above, for example, the producer of an interactive entertainment project, goes and creates and/or reviews each of the items or files making up the project, STEP 106. As indicated above, typically there are a multitude of items or files that can make up a project, for example, there can be thousands of files making up an interactive entertainment software project. In some cases, the producer may create dummy files or find existing files that should become part of the project.

Each of these files or items is reviewed to determine if the file or item should be classified as being within or without the workflow or workflow statusing process, STEP 108. As indicated above, typically there are number of items or files of a project that are not considered key to the project and thus are not considered as being worthy of being tracked as part of the workflow. These items or flies are generally referred to hereinafter as items or files not in the workflow. The items or files that are to be tracked are tacitly identified and classified as being a file in the workflow.

Such a classification system, however, shall not be construed as being a limitation on the number of items and files that can be classified as being in the workflow. It is within the scope of the present invention for any of a number of items or files (“NF”) making up the project to be tracked as being part of the workflow up to and including all of the items or files making up the project (i.e., 1≦NF≦all).

After appropriately classifying the items or files. The workflow database is updated to reflect the classification status for each of the items/files listed therein, STEP 110. It should be recognized that it is not uncommon for a database to exist that lists each of the items/files making up the project and including information for each of these items/files. As such, it is within the scope of the present invention for such an informational database to be adapted and modified so as to include the information, flags or other data entries otherwise described herein of the present invention.

In one embodiment of the present invention, the workflow status flag or data field is adapted so as to be used to classify the items or files making up the project into within or without the workflow category. For example, one status flag or data field entry is set so as to indicate that the so-identified item or file is not in (i.e., without) the workflow and thus not being tracked using the methodology of the present invention. The setting of any other status flag or data field entry indicates that the so-identified item or file is in the workflow and thus being tracked according to the method of the present invention.

More specifically, the project manager or producer using the appropriate technique appropriately selects one or more of the files that comprise the files that should be designated as being in the workflow. The project manager then selects, for example by click-on an icon (e.g., icon titled manage workflow) on the desktop, a functionality for updating the workflow database. The project manager/producer then takes the appropriate actions to add the one or more files to the workflow.

In an illustrative embodiment a dialog box such as that shown in FIG. 6A appears in response to clicking-on the icon. Using the various fields provided in the dialog box, the project manager/producer clicks on the “add/modify . . . ” portion, assigns the item or file or the selected item/files to “no specific user”, for example; and inputs or does not input a due date using other fields of the dialog box.

After so updating the database, the project management team designee/project manager/producer then assigns each of the items or files to an individual or user, STEP 112 so that the required item or file can be produced in its final form, which is more particularly described below in connection with FIG. 3 starting with STEP 300. Such assigning can be accomplished at the time the item or file is initially entered into the database or some later time. At the time the file is being assigned, the project management team designee/project manager/producer also can specify the due date. The process of assigning workflow items/files to users is repeated as and when needed until all of the items or files identified as comprising the workflow are assigned, step 114.

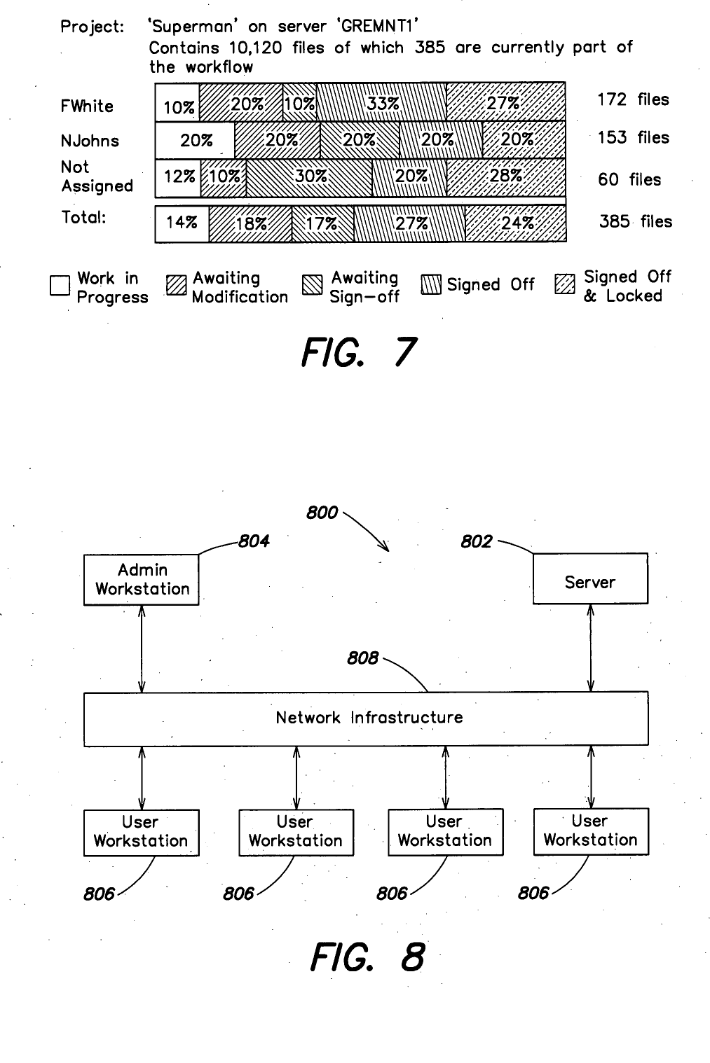

After the database has been updated with all the different types of items/files (i.e., in or out of workflow), the work status of the items/files making up the workflow is evaluated and/or monitored, STEP 120, including the running of reports or the like, STEP 122. An illustrative report that can be run to status the workflow files associated with an interactive entertainment software product is shown in FIG. 7. Such monitoring and running or reports as well as other administrative project management actions are continued (NO, STEP 124) until a determination is made that all activities are completed. If all activities being tracked are completed (YES, STEP 124) then the monitoring and reporting process is ended, STEP 130.

After the database has been updated with all the different types of items/files (i.e., in or out of workflow), STEP 110 and after the process of assigning items/files has been started, STEP 112, the project management team designee/project manager/producer has a continuing responsibility to update the workflow database to include items/files being added to the project as well reclassifying items in the project as being within or without the workflow. Now with reference also to FIG. 1B, the project management team designee/project manager/producer identifies each file/item being added to the project and reviews each added item/file to determine its classification as being within or without the workflow, STEPS 140, 142. This process is similar to that described above for steps 106, 108 as such reference should be made to the discussion for these steps for additional details of this process.

In the case of a project item/file to be re-classified, the project management team designee/project manager/producer identifies the item/file and determines if it is to be added to the workflow or is to be removed from the workflow, STEP 150. Based on this determination, the item/file is appropriately reclassified, STEP 152.

Following either reclassification or addition of a file(s), STEPS 142, 152, the workflow database is updated to include the new item/file including classification or updated to reflect the reclassification of an exiting item/file, STEP 144. Following such updating, a determination is made to see if the new item/file or the re-classified item/file is within the workflow, STEP 146. If it is determined that the new item/file or the re-classified item/file is within the workflow (YES, STEP 146) then the process returns to assigning the new item/file or the re-classified item/file, FIG. 1A, STEP 112. If the new item/file or the re-classified item/file is a file without the workflow (NO, STEP 146) then the process returns to monitoring status, FIG. 1A, STEP 120.

As indicated above, the project management team designee/project manager/producer assigns each of the items or files to an individual, STEP 112 so that each required item or file can be produced in its final form. Now referring to FIG. 3 there is shown a flow diagram of the method according to the present invention illustrating functionalities at the work level that are undertaken after the item/file has been assigned to the worker/individual.

After an item or file is assigned, the responsible individual identifies each of the items or files he/she has been assigned and in accordance with applicable due dates, he/she identifies the order in which these identified files/items should be worked. Once the workload and work order is determined, the item or file is accessed so that the required activity can be performed, STEP 300. Such accessing can take the form of checking the item or file out from a specified storage location. For example, the computer file is listed in a computer file management type of database where files being accessed and opened are formally checked out of the database so that another user cannot access the file that is in-process or being worked on.

The user performs the activity required or works on the file/item, Step 302. It should be recognized that the activity required can be any of a number of activities that can be performed in connection with the item/file so as to yield an item/file in its final form, STEP 302. In addition to item/file creation, this includes reviews of in-process versions, modifying an earlier version to correct a mistake or for improvement and updating an earlier version due to changing requirements.

Upon completing the designated work assignment, the user accesses the workflow database, STEP 304 to input a status charge 306, STEP 306. In addition to reflecting completion of a work assignment, the status change also is in indication that the item/file is ready to precede to the next step or level of the workflow. As such, it is an indicator to the next person in the workflow that the item or file is available to them so that they can carry out the next work assignment.

Before accepting the inputted status change, an evaluation is made to determine if the user is allowed to make that status change, STEP 308. In other words, the user rights set defined for the user is evaluated to determine if the status change is within or not within the defined user rights set. If the inputted change is not within the defined user rights set (NO, STEP 308), then an error message is outputted and the inputted status change is not accepted, STEP 310.

If the inputted change is within the defined user rights set (YES, STEP 308), then the inputted status change is accepted and the workflow database is updated accordingly, STEP 312. A further evaluation is made to determine if the item/file is in its final complete form, STEP 314 and if it is not (NO, STEP 314) then the next action according to the workflow is performed, STEP 316. In other words, the process described by steps 300-312is repeated.

If the item/file is complete/in its final form (YES, STEP 314), then another status change is inputted to reflect this completion status, STEP 318. This status change also is checked to see if the user making the input is allowed to make this type of status change, STEP 320. If the inputted change is not within the defined user rights set for the user (NO, STEP 320), then an error message is outputted and the inputted status change is not accepted, STEP 310. If the inputted change is within the defined user rights set (YES, STEP 308), then the inputted status change is accepted and the item/file is locked out or other action taken to prevent further or unauthorized modification of the item/file by a user not having the appropriate rights set.

Typically, once an item/file is in its final form a process is instituted to prevent further access to the item/file by any user except those having an administrative rights set such as the project management team designee/project manager/producer. In this way, completed items or files cannot be checked our or modified without first getting the approval of the project management team designee/project manager/producer. Thus, the locking out process also typically is set so that only certain users, those having the administrative level user rights set, can lock out the file and thus input a status change that would lead to a lock out of the item/file.

If a user wants to work on an item/file that is in the locked out status category, a request typically is sent to the project management team designee/project manager/producer to institute an un-locking process, STEP 330 for the given item or file, along with a reason. If the request is acceptable, a status change is inputted, STEP 332, and the change is evaluated to determine if the user making the input is allowed to make this type of status change, STEP 334. If the inputted change is not within the defined user rights set (NO, STEP 334), then an error message is outputted and the inputted status change is not accepted, STEP 310. If the inputted change is within the defined user rights set (YES, STEP 334), then the inputted status change is accepted, the item/file is un-locked, and the workflow database is updated to reflect the status change, STEP 336.

As noted above, the status change also provides an indication that the file is ready to precede to the next step or level of the workflow. As such, the status change provides an indicator to the next person in the workflow that an item or file is available to them so that they can carry out the work assignment causing the re-opening of the item/file. Thus, the process described by steps 300-312 is repeated to carry out the activity causing such re-opening until it is again determined that the item/file should be again locked out.

In addition to status changes that occur during the normal processing of the item/file, a status change can to be implemented by one who is not presently tasked with performing the next work assignment, STEP 316. For example, the user who just competed a work assignment may determine that the item/file needs to be re-worked or modified. Thus, this other user can access the workflow database, STEP 304 and input a status change, STEP 306. This inputted change is further evaluated to determine if the inputted status change is within the defined set of user rights. If the inputted change is not within the defined user rights set (NO, STEP 308), then an error message is outputted and the inputted status change is not accepted, STEP 310. In this case the other user would have to contact one with the administrative level user rights set to get a status change implemented.

If the inputted change is within the defined user rights set (YES, STEP 308), then the inputted status change is accepted and the workflow database is updated to reflect the status change, STEP 312. Because the status change provides a new status level and thus an indicator of a work assignment to the person having responsible for the action defined by the re-defined status level, in effect the workflow for the item/file is changed without having to go through a formalized process to change the workflow. In contrast to task based management techniques, in the methodology of the present invention the workflow is adjusted and modified without the need to redefine a duration for the task or by redefining or adding logic paths.

In sum, the above-described methodology provides a mechanism to define the workflow paths by means of status levels and to change the workflow path by defining or re-defining the status level. In other words, the methodology of the present invention allows the work process to be controlled and defined by the status level provided in the database and to easily modify the work process by re-defining the status level. The methodology also provides control over such changes by establishing a hierarchal user status changing rights set for each user or user type that limits the ability of certain users to make certain changes to the workflow process and reserves the decision making relative to other changes to the workflow process to those having a broader set of user status changes rights, typically those given to administrators, project managers or producers.

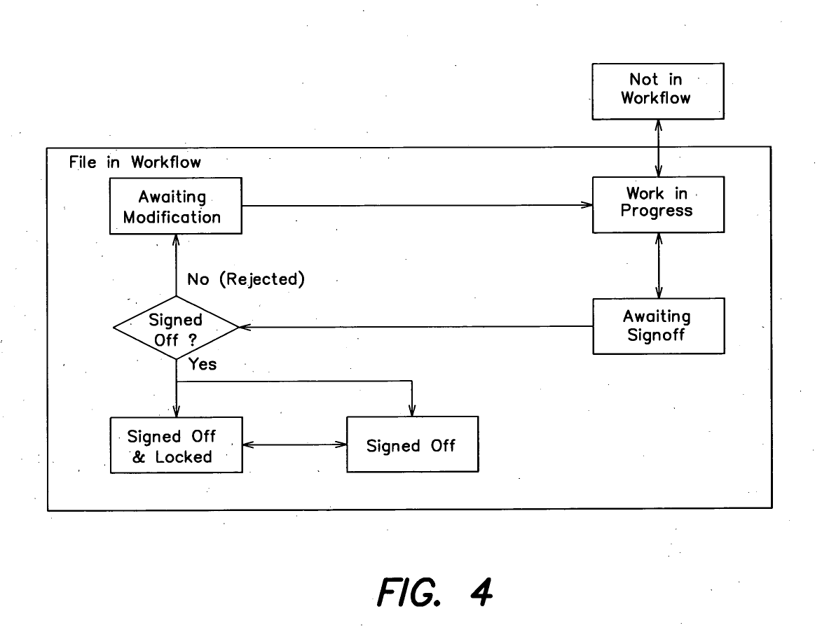

The methodology of the present invention and its use for controlling and monitoring the development of interactive entertainment software products, more particularly the computer files for such a software product can be best understood from the following discussion when viewed in connection with FIGS. 4-7. Reference also should be made to the foregoing discussion for FIGS. 1-3 for details of method steps not other wise shown in FIGS. 4-7.

When a producer creates a project or starts working on an existing project, the producer at least creates dummy files or pulls in other existing files that should become files of the workflow (e.g., like the main character models, level files, etc) for the project. The producer also develops a workflow for the project such as that shown diagrammatically in FIG. 4 that delineates different possible work paths for the development of a file of the project. Based on this the producer defines the different status levels generally corresponding to the workflow. See FIG. 1A, STEP 102 and FIG. 1B, STEPS 210-214.

These status levels and a brief description thereof follows.

| Status | Description |
|---|---|
| 1 | Not in workflow; default status for files that are not |
| | added to workflow. |
| 2 | Work in Progress (WIP), default status for files added to |
| | workflow; status when someone is working file. |
| 3 | Awaiting Modification (AMO), user needs to change a |
| | file. |
| 4 | Awaiting Sign-off (ASO), user finished file and wants |
| | project manager/producer sign-off. |
| 5 | Signed-off; file is signed off but changeable, e.g., file is |
| | good for mastering, but artist can still work on it. |
| 6 | Signed-off and locked; file signed off and locked |
| | against any modification. |

The producer also reviews the different users and defines the different user types. See FIG. 1A, STEP 104 and FIG. 2, STEPS 220-226. In the present illustrative embodiment, and to keep the usability high and the system simple, there is one user right set for project managers/producers and another user right set for simple users. The rights set for simple users typically only allows them to change the Sign-Off status to WIP, ASO, AMO and only if the file is already part of the workflow status. The rights set for simple users also can be established to have a narrower scope. The rights set for project managers allows them to change the status of every file to and from each of the 6 statuses or status levels. As such, project managers can add or remove files from the workflow and workflow status.

After defining the rights set for the different user types and defining the different status levels, the producer enters all of the files belong to the workflow into the workflow status. Specifically, the producer using an appropriate technique selects one or more of the files that comprise the files that should be designated as being in the workflow. The producer then selects, for example by click-on an icon (e.g., icon titled manage workflow) on the desktop, a functionality for updating the workflow status. See FIG. 1A, STEPS 106-110.

In an illustrative embodiment a dialog box such as that shown in FIG. 6A appears in response to clicking-on the icon on the desktop. Using the various fields provided in the dialog box, the project manager/producer would click on the “add/modify . . . ” portion and assign the item or file or the selected item/files to “no specific user” for example, and inputs or does not input a due date using other fields of the dialog box. As a result of the foregoing, a status flag or data field is set so the workflow status is set at status level 2, corresponding to work in progress. This updating also allows the project manager/producer to status the workflow.

After all files that are designated as being in the workflow are entered so as to have a workflow status, the producer, as and when needed, assigns a given file(s) to a specific user so they can produce/create the file. See FIG. 1A, STEP 112. Specifically, the producer again selects, for example by click-on an icon (e.g., icon titled manage workflow) on the desktop, a functionality for updating the workflow status. In an illustrative embodiment a dialog box such as that shown in FIG. 6B appears in response to clicking-on the icon.

Using the various fields provided in the dialog box, the project manager/producer again clicks on the add/modify field. He also enters the name or identifier of the user the file is to be assigned to (e.g., Susi) in the assigned to field of the dialog box and enters a due date (e.g., 08.11.02) in the due date field thereof. The names can be selected from a pull down submenu and the date inputted by means of the illustrated pop-up calendar. Although this should not reset a previously set status flag or data field, this allows the user to determine the assigned work. Typically the producer also will issue some communication that work assignments will be/are assigned to a given user.

Each user assigned to the project, performs searches to determine and to identify any files assigned to them and statused as being in-progress (i.e., status level 2). If such a file is identified, the user works on the file, for example, by first checking the file out. Typically icons relating to files are colored so as to help identify the status or state of a file before it is opened. See FIG. 3, STEPS 300, 302.

After performing the work assignment, the user checks the file back in. Typically the check-in process also is established so that a process for automatically inputting a workflow status change appears. Alternatively, the user initiates the process for updating the status change. The user typically selects the new status based on the completed work assignment, which status is checked to see if it is within the rights set for the user. In another embodiment, the user selects the status from a pull down list that only includes those status changes within the rights set for that user. See FIG. 3, STEPS 304-312.

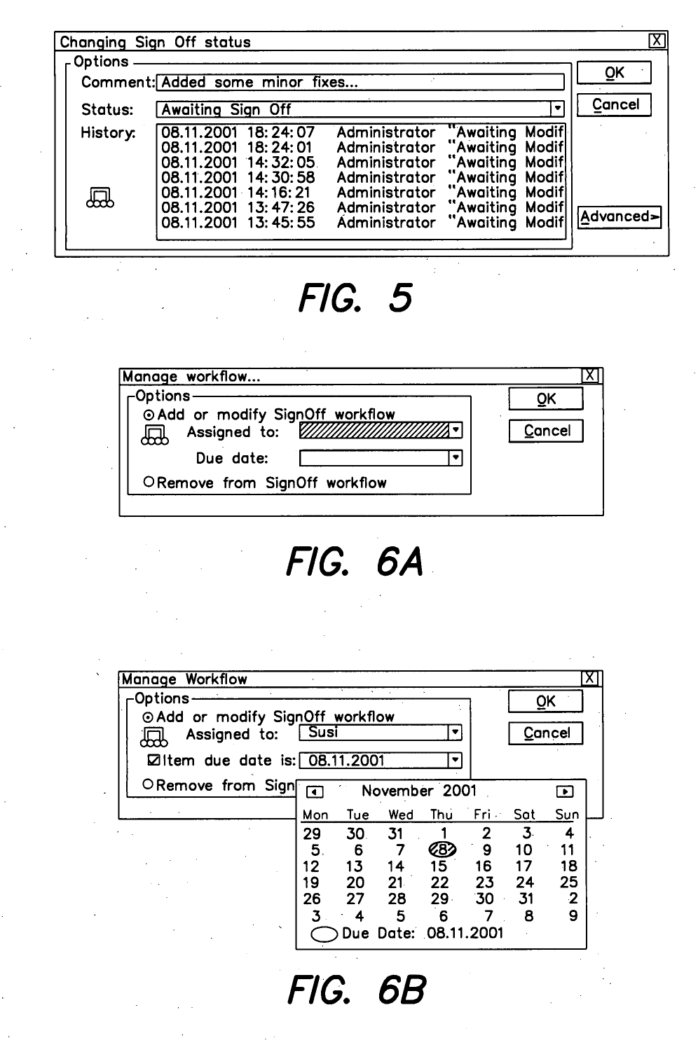

In an illustrative embodiment a dialog box such as that shown in FIG. 5 pops up or appears so that the status shown thereon can be changed or updated. Using the various fields provided in the dialog box, the user selects the new status from the pull down submenu for the status field. The user also can provide comments describing the work assignment that was performed. Further, the dialog box includes a read-only history field that display a history of the status changes for that file that in a further embodiment includes user added comments. As a result of the foregoing, the status flag or data field is set so the workflow status is set at different status level generally corresponding to the next step or work assignment in the workflow. For example, the status flag would be set to level 4 indicating that the file is awaiting sign-off by the project manager.

The producer periodically reviews or searches the database to identify files having workflow statuses that correspond to work assignments that are within his scope of responsibility. For example, the producer searches the database to find files having an awaiting sign-off status, for all users or just a specific user. The producer reviews such a file and if it is unacceptable, the producer re-statuses the file using the process described above to an awaiting modification status (status level 3) and where applicable adds a comment. This re-statusing in effect re-routes the file back to the user for modification/correction. The user, thereafter would fix the file and restart the awaiting sign-off process.

If the file is determined to be acceptable, the producer sets the status or status flag for the file to one of two values. The producer sets the status so as to be in a signed-off state, status level 5 or sets the status so as to be in a signed-off and locked state, status level 6. When the status of the file is set as signed-off and locked, the file cannot be checked out and it cannot be further modified.

The foregoing process is repeated for each file having a workflow status until all such files have a status that is set as signed-off and locked.

Because, status or status flags are changed when a given user completes the work assignment, a producer can use the workflow status in the database at any time to determine the status of the project at any level he may choose. For example, the producer can determine the overall status of the project by running a workflow status report having an output such as that shown in FIG. 7. The illustrated report is in bar chart form and provides a work status for each user, the not assigned files and for the overall project based on the defined workflow status levels. It should be recognized that other management reports, such as workflow load for each user, are available to the producer.

From such reports, the producer can determine where the project stands using the status information available from the workflow database. Thus, and in comparison to prior art techniques, the producer can obtain such information and make such determinations directly using workflow status information contained in the workflow database without the need for status meetings or memos as is needed with the prior art techniques.

In sum, the monitoring and control methodology of the present invention in an expansive view allows management of a project, such as the content development project for an interactive entertainment software product, to easily monitor and determine the overall status of the project as well as status for one or more specific items or files directly from a database that is updated by the users performing the work assignments. The establishment of the various status levels are created and set by considering the requirements and process of the workflow for a given project and are not set in an arbitrary fashion. The methodology also is such that it provides a comparatively simple system for statusing so that usability is kept high.

Referring now to FIG. 8, there is shown a schematic view of a computer system 800 including an applications program embodying the methodology of the present invention. The computer system includes a server 802, an administrative level workstation 804, a plurality of workstations 806 for users and a network infrastructure 808 that operably interconnects the server to each of the administrative workstation and the user workstation. The server 802 and workstations 804, 806 are any of a number of microprocessor driven computers known to those skilled in the art. The network infrastructure 808 is any of a number of networks infrastructures known to those skilled in the art such as Ethernet and token ring.

In use, the simple user checks the workflow file out of the server 802 and works on the file at one of the user workstations 806 via the network infrastructure. After completing the work assignment, the user checks the file back into the server 802. At the same time, an applications program(s) is available for execution on each of the workstations 804, 806 for monitoring, controlling and statusing the workflow.

Although a preferred embodiment of the invention has been described using specific terms, such description is for illustrative purposes only, and it is to be understood that changes and variations may be made without departing from the spirit or scope of the following claims.

What is claimed is:

1. A method for controlling work of a project, comprising the steps of: defining S status levels (S≧2), where the number and definition of each status level relates to at least certain of various workflow paths of a workflow for the project; and defining U user statusing rights sets (U≧2), one user rights set for each type of user assigned to the project.

2. The method of claim 1, further comprising the steps of:
classifying each of work items of the project as one of being within the workflow or being without the workflow, where there is at least one work item classified as being within the workflow; and
using the defined S status levels to define a work status for each work item that is classified as being within the workflow.

3. The method of claim 2, further comprising the steps of:
classifying each work item being added to the project as one of being within the workflow or being without the workflow; and
using the defined S status levels to define a work status for each added work item that is classified as being within the workflow.

4. The method of claim 2, further comprising the steps of:
re-classifying one or more work items of the project as one of being within the workflow or being without the workflow; and
using the defined S status levels to define a work status for each of the re-classified work items that is re-classified as being within the workflow.

5. The method of claim 2, further comprising the steps of:
assigning each work item that is classified as being within the workflow to one of users assigned to the project.

6. The method of claim 1, further comprising the step of:
providing an informational database including identifiable entries for each of the work items of the project; and
wherein one of the identifiable entries is one of the defined S status levels.

7. The method of claim 2, further comprising the step of:
providing an informational database including identifiable entries for each of the work items of the project; and
wherein one of the identifiable entries is one of the defined S status levels.

8. The method of claim 5, further comprising the steps of:
providing an informational database including identifiable entries for each of the work items of the project;
wherein one of the identifiable entries is one of the defined S status levels; and
wherein another of the identifiable entries is representative of the one of the users assigned to the work item corresponding to identifiable entries.

9. The method of claim 2, further comprising the steps of:
requesting a change in the work status for one of the work items from one of the defined S status levels to another of the defined S status levels;
evaluating the user rights set of the one user requesting the change in the work status;
changing the work status to said another of the defined S status levels in the case the user rights set allows the change, and
not changing the work status in the case the user rights set does not allow the change.

10. The method of claim 9, further comprising the step of:
performing a work function relating to the said one of the defined S status levels before said requesting a change in the work status.

11. The method of claim 9, further comprising the step of:
performing a work function relating to the said another of the defined S status levels.

12. The method of claim 1, further comprising the steps of:
using the defined S status levels to define a work status for each work item that is classified as being within the workflow;
requesting a change in the work status for one of the work items from one of the defined S status levels to another of the defined S status levels;
evaluating the user rights set of the one user requesting the change in the work status;
changing the work status to said another of the defined S status levels in the case the user rights set allows the change, and
not changing the work status in the case the user rights set does not allow the change

13. The method of claim 12, further comprising the step of:
performing a work function relating to the said one of the defined S status levels before said requesting a change in the work status.

14. The method of claim 12, further comprising the step of:
performing a work function relating to the said another of the defined S status levels.

15. A method for developing files of a software project, comprising the steps of:
defining S status levels (S≧2), where the number and definition of each status level relates to at least certain of various workflow paths of a workflow for development of the files; and
defining U user statusing rights sets (U≧2), one user rights set for each type of user assigned to the software project.

16. The method of claim 15, further comprising the steps of:
classifying each of the files as one of being within the workflow or being without the workflow, where there is at least one file classified as being within the workflow; and
using the defined S status levels to define a work status for each file that is classified as being within the workflow.

17. The method of claim 16, further comprising the steps of:
classifying each file being added to the project as one of being within the workflow or being without the workflow; and
using the defined S status levels to define a work status for each added file that is classified as being within the workflow.

18. The method of claim 16, further comprising the steps of:
re-classifying one or more files of the project as one of being within the workflow or being without the workflow; and
using the defined S status levels to define a work status for each re-classified file that is re-classified as being within the workflow.

19. The method of claim 16, further comprising the steps of:
assigning each file that is classified as being within the workflow to one of the users assigned to the project.

20. A computer program product for use with a microprocessor of a computer to develop files of a software project, said computer program product comprising:
a computer-readable medium bearing program code, the program code including:
a first computer-readable program code segment for defining S status levels (S≧2), where the number and definition of each status level relates to at least certain of various workflow paths of a workflow for development of the files; and
a second computer-readable code segment for defining U user statusing rights sets (U≧2), one user rights set for each type of user assigned to the software project.
